(19) United States
(12) Patent Application Publication
(10) Pub. No.: US 2017/0346314 A1
(43) Pub. Date: Nov. 30, 2017

(54) BATTERY PROTECTION BOARD, BATTERY AND MOBILE TERMINAL

(71) Applicant: GUANGDONG OPPO MOBILE TELECOMMUNICATIONS CORP., LTD., Dongguan (CN)

(72) Inventors: Chen TIAN, Dongguan (CN); Jialiang ZHANG, Dongguan (CN)

(21) Appl. No.: 15/606,060

(22) Filed: May 26, 2017

Related U.S. Application Data
(63) Continuation of application No. PCT/CN2016/083697, filed on May 27, 2016.

(51) Int. Cl. H02J 7/00

(52) U.S. Cl. CPC H02J 7/0029; H02J 7/0091; H02J 7/0077; H02J 2007/0039; H02J 2007/004; H02J 2007/0037

(57) ABSTRACT

Embodiments of the present disclosure provide a battery protection board, a battery and a mobile terminal. The battery protection board includes a first protection circuit, a current sensing element and a battery voltmeter. The first protection circuit is configured to control the charge and discharge circuit to turn on or off. The current sensing element is configured to be coupled to the charge and discharge circuit in series. The battery voltmeter is coupled to the current sensing element and configured to detect a voltage drop generated by an impedance of the current sensing element and to determine an electric quantity of the battery according to the voltage drop. The embodiments of the present disclosure not only reduces the number of elements in the battery protection board thereby saving an area and cost of the battery protection board, but also reduces a failure rate of the battery protection board.

### CROSS-REFERENCE TO RELATED APPLICATIONS

This application is a continuation of International Application No. PCT/CN2016/083697, filed on May 27, 2016, the entire contents of which is incorporated herein by reference.

### FIELD

Embodiments of the present disclosure relate to a field of mobile terminals, and more particularly, to a battery protection board, a battery and a mobile terminal.

### BACKGROUND

At present, mobile terminals (such as smart phones) are increasingly favored by consumers, and their safety has been concerned by the consumers.

A battery protection board is needed to be installed for a battery in the mobile terminal, so as to ensure the safety of the battery. In the related art, the battery protection board has a wide variety of configurations, and the mobile terminal has a special requirement for its battery protection board in terms of integration and size. Therefore, there is a need to provide the battery protection board suitable for the mobile terminal.

### SUMMARY

A battery protection board is provided. The battery protection board includes a first protection circuit, a current sensing element and a battery voltmeter. The first protection circuit is configured to be coupled to a charge and discharge circuit of a battery and configured to control the charge and discharge circuit to turn on or off. The current sensing element is configured to be coupled to the charge and discharge circuit in series. The battery voltmeter is coupled to two terminals of the current sensing element and configured to detect a voltage drop generated by an impedance of the current sensing element and to determine an electric quantity of the battery according to the voltage drop during a charge and discharge process of the battery via the charge and discharge circuit.

A battery is provided. The battery includes a cell and the battery protection board described above. The battery protection board is coupled to the cell.

A mobile terminal is provided. The mobile terminal includes a charging interface and the battery described above. The battery is coupled to the charging interface.

### BRIEF DESCRIPTION OF THE DRAWINGS

In order to make the technical solutions of embodiments of the present disclosure more clearly, the accompanying drawings used in the description of embodiments of the present disclosure are briefly described hereunder. Obviously, the described drawings are merely some embodiments of present disclosure. For those skilled in the art, other drawings can be obtained based on these drawings without any creative work.

FIG. 1 is a schematic diagram illustrating a battery protection board.

FIG. 2 is a schematic diagram illustrating a circuit of a battery protection board according to an embodiment of the present disclosure.

FIG. 3 is a schematic diagram illustrating a circuit of a battery protection board according to an embodiment of the present disclosure.

FIG. 4 is a schematic diagram illustrating a circuit of a battery protection board according to an embodiment of the present disclosure.

FIG. 5 is a block diagram illustrating a battery according to an embodiment of the present disclosure.

FIG. 6 is a block diagram illustrating a mobile terminal according to an embodiment of the present disclosure.

### DETAILED DESCRIPTION

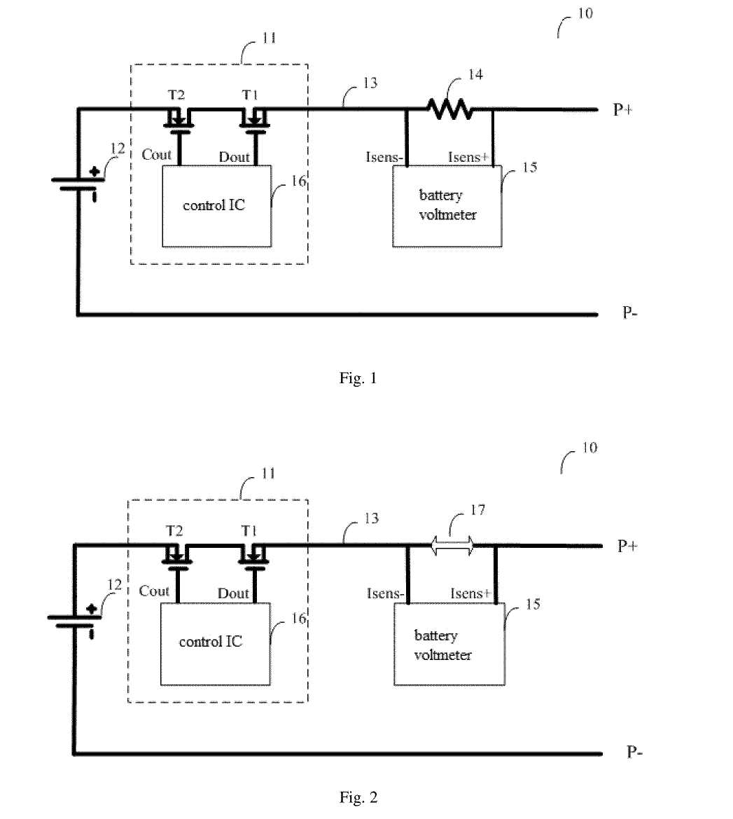

FIG. 1 is a schematic diagram of a battery protection board. As illustrated in FIG. 1, the battery protection board 10 includes a first protection circuit 11, a current sensing resistor 14 and a battery voltmeter 15.

The first protection circuit 11 is configured to be coupled to a charge and discharge circuit 13 of a battery. The first protection circuit 11 is configured to control the charge and discharge circuit 13 to turn on or off.

The current sensing resistor 14 is configured to be coupled to the charge and discharge circuit 13 in series.

The battery voltmeter 15 is coupled to two terminals of the current sensing resistor 14. The battery voltmeter 15 is configured to detect a voltage drop generated by an impedance of a current sensing resistor 14 and to determine an electric quantity of the battery according to the voltage drop during a process in which the battery is charged or discharges via the charge and discharge circuit 13.

In at least one embodiment, the first protection circuit 11 in FIG. 1 includes a control IC (integrated circuit) 16 and a pair of back-to-back MOS (Metal Oxide Semiconductor) transistors T1 and T2. The control IC 16 is coupled to the MOS transistor T1 via a terminal Dout and coupled to the MOS transistor T2 via a terminal Cout.

In at least one embodiment, the terminal Cout may be configured to be an overcharge control terminal. The MOS transistor T2 is controlled to turn on or off according to a gate voltage of the MOS transistor T2.

In at least one embodiment, the terminal Dout may be configured to be an overdischarge, overcurrent, or short-circuit control terminal. The MOS transistor T1 is controlled to turn on or off according to a gate voltage of the MOS transistor T1.

In at least one embodiment, P+ represents a positive electrode of the battery protection board 10, and P− represents a negative electrode of the battery protection board 10. Or, P+ represents a positive electrode of a cell 12 coupled to the battery protection board 10, and P− represents a negative electrode of the cell 12 coupled to the battery protection board 10.

Since the size of the mobile terminal is getting smaller and smaller, requirements on the integration level of the circuit thereof are getting higher and higher. The battery protection board in an embodiment of the present disclosure not only incorporates the protection circuit, but also incorporates the battery voltmeter. Therefore, the battery protection board in the present disclosure has a higher integration level, and is suitable to be applied in the mobile terminal for protecting the battery of the mobile terminal.

In order to further reduce the size of the mobile terminal, in at least one embodiment, the current sensing resistor 14 may be removed, and the battery voltmeter 15 may be coupled to two terminals of one or more MOS transistors. That is, a resistor R_{ds} of the one or more MOS transistors may be configured to replace the current sensing resistor 14 to achieve the current detection function, which may further reduce the number of elements in the battery protection board 10.

In the at least one embodiment, there is a higher requirement on the reliability of the MOS transistor(s) in the protection circuit 11.

In at least one embodiment, in FIG. 2, the battery voltmeter 15 may be coupled to a wire 17 (the wire 17 may be a trace in the battery protection board 10, which may be an impedance-designed copper trace) in the battery protection board 10. That is, the resistor of the wire 17 in the battery protection board 10 is configured to replace the current sensing resistor 14 in FIG. 1. This not only can reduce the number of elements in the battery protection board, thereby saving the area and cost of the battery protection board, but also can reduce the failure rate of the battery protection board.

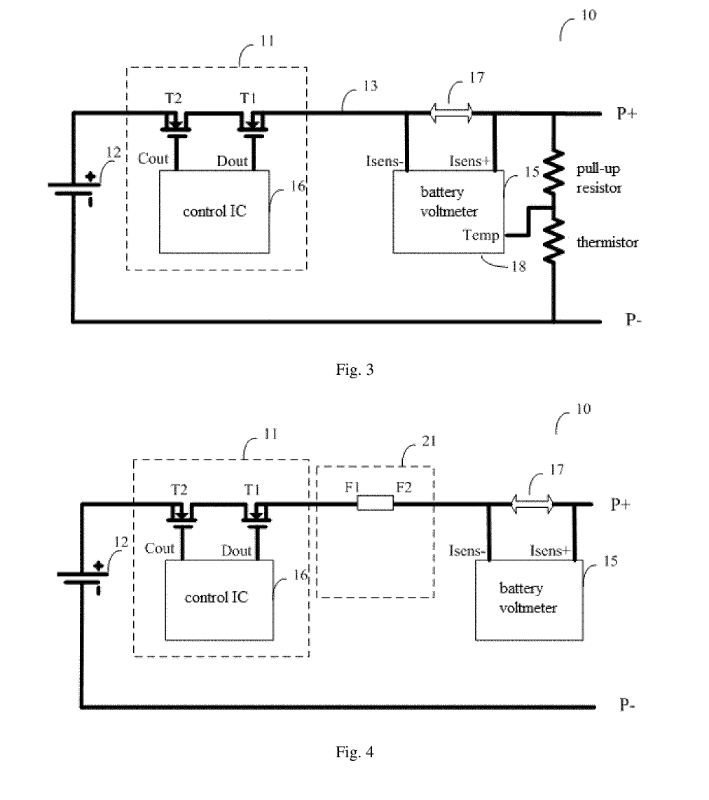

The impedance of the wire 17 in the battery protection board 10 may change as the temperature of the battery or the battery protection board 10 changes. In the case of using the wire 17 to replace the current sensing resistor 14, in at least one embodiment, the temperature detection circuit 18 may be added to the battery protection board 10 (as shown in FIG. 3) in order to measure the current flowing through the wire 17 more accurately.

In at least one embodiment, the battery protection board 10 further includes the temperature detection circuit 18. The temperature detection circuit 18 is configured to detect a temperature of the battery or the battery protection board 10. The battery voltmeter 15 may be coupled to the temperature detection circuit 18. The battery voltmeter 15 may be configured to: determine an impedance of the wire 17 at a current temperature according to the temperature detected by the temperature detection circuit 18 and a correspondence between the impedance of the wire 17 and the temperature (the correspondence may be pre-stored in a memory of the battery protection board 10); determine a current flowing through the wire 17 according to the impedance of the wire 17 at the current temperature and the voltage drop generated by the impedance of the wire 17 at the current temperature; and determine the electric quantity of the battery according to the current flowing through the wire 17.

In at least one embodiment, the temperature detection circuit 18 may be integrated in the battery voltmeter 15. In at least one embodiment, the temperature detection circuit 18 and the battery voltmeter 15 may be provided separately.

In at least one embodiment, the temperature detection circuit 18 may be configured to detect the temperature via a thermistor. In some embodiments, the thermistor may be a negative temperature coefficient (NTC for short) resistor, or a positive temperature coefficient (PTC for short) resistor. In at least one embodiment, one terminal of the thermistor is coupled to the positive electrode P+ of the battery protection board 10 via a pull-up resistor.

In order to further improve the protection performance of the battery protection board 10, in at least one embodiment, as shown in FIG. 4, the battery protection board 10 may further include a second protection circuit 21. The second protection circuit 21 may be configured to provide protection for the charge and discharge process of the battery in the case that the first protection circuit 11 is disabled.

In at least one embodiment, the second protection circuit 21 may be configured to provide overvoltage or overcurrent protection for the charge and discharge process of the battery via a fuse. As shown in FIG. 4, the second protection circuit 21 may include a first fuse pin F1 and a second fuse pin F2. When the overvoltage or overcurrent occurs in the charge and discharge circuit 13, the fuse between the first fuse pin F1 and the second fuse pin F2 in the second protection circuit 21 is blown.

By setting the two protection circuits, the safety of the battery in the mobile terminal may be further improved during the charge and discharge process.

In at least one embodiment, the first protection circuit may be a switch.

In at least one embodiment, the current sensing element may be the switch.

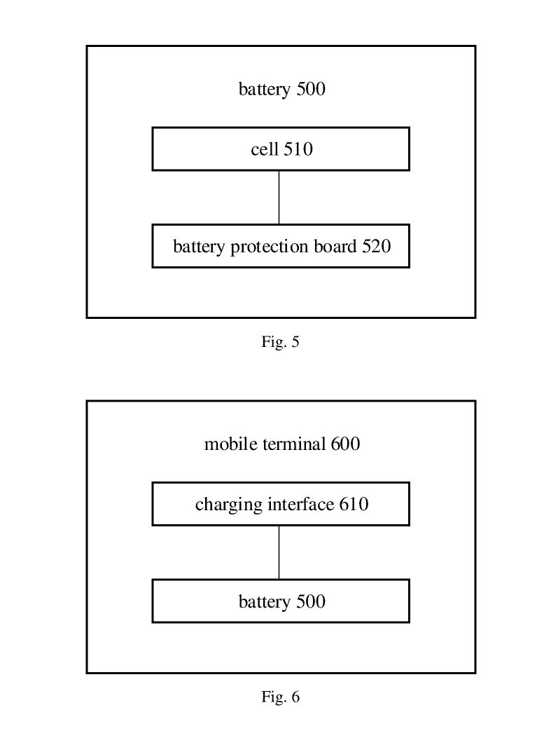

The battery protection board according to embodiments of the present disclosure is described in detail with reference to FIGS. 1 to 4. The battery and the mobile terminal in embodiments of the present disclosure will be described in detail below with reference to FIGS. 5 and 6.

FIG. 5 is a block diagram illustrating a battery according to an embodiment of the present disclosure. As illustrated in FIG. 5, the battery 500 includes a cell 510 and a battery protection board 520. The battery protection board 520 is coupled to the cell 510.

It should be understood that the battery protection board 520 in FIG. 5 may be the battery protection board described above, which will not be elaborated here for clarity.

FIG. 6 is a block diagram illustrating a mobile terminal according to an embodiment of the present disclosure. As illustrated in FIG. 6, the mobile terminal 600 includes a charging interface 610 and the battery 500. The battery 500 is coupled to the charging interface 610.

In at least one embodiment, the mobile terminal 600 is configured to support a first charging mode and a second charging mode. A charging speed of the second charging mode is greater than a charging speed of the first charging mode.

In at least one embodiment, a charging current of the second charging mode is greater than a charging current of the first charging mode.

In at least one embodiment, a charging voltage of the second charging mode is greater than a charging voltage of the first charging mode.

In at least one embodiment, the mobile terminal 600 is configured to perform a bidirectional communication with an adapter via the charging interface 610, under the second charging mode.

The first charging mode is a normal charging mode and the second charging mode is a fast charging mode. Under the normal charging mode, the adapter outputs a relatively small current (typically less than 2.5 A) or charges a battery in a charging device (such as a terminal) with a relatively small power (typically less than 15 W). While, under the fast charge mode, the adapter outputs a relatively large current (typically greater than 2.5 A, such as 4.5 A, 5 A or higher) or charges the battery in the charging device (such as the terminal) with a relatively large power (typically greater than or equal to 15 W), compared to the normal charging mode. In the normal charging mode, it may take several hours to fully fill a larger capacity battery (such as a battery with 3000 mAh), while in the fast charging mode, the period of time may be significantly shortened when the larger capacity battery is fully filled, and the charging is faster.

The communication process between the mobile terminal and the adapter may not be specifically defined here. For example, the communication between the mobile terminal and the adapter may refer to a handshake process between the mobile terminal and the adapter. That is, the mobile terminal and the adapter may determine the charging mode, the charging voltage, the charging current and other parameters by the handshake.

Those skilled in the art should appreciate that units and algorithm steps in each example described in connection with the embodiments disclosed herein can be implemented in electronic hardware, or a combination with computer software and electronic hardware. Whether these functions are implemented in hardware or software depends on the specific application and design constraints of the technical solution. The skilled in the art may use different methods to implement the described functions for each particular application, but such implementations should not be considered beyond the scope of the present disclosure.

It should be apparent to those skilled in the art that the specific processes of the systems, apparatuses and units described above may be referred to the corresponding processes in the foregoing embodiments of the methods and will not be described here for the convenience and simplicity of description.

In several embodiments provided in the present disclosure, it should be understood that the disclosed systems, apparatuses, and methods may be implemented in other ways. For example, the embodiments of the apparatuses described above are merely illustrative, for example, the division of units is a logical function division only, and there may be another division in actually implementing, for example, multiple units or components may be combined or may be integrated into another system, or some features may be ignored or not executed. In other respects, the shown or discussed coupling or direct coupling or communication connection between each other may be via interfaces, and the indirect coupling or communication connection between apparatuses or units, which may be electrical, mechanical, or otherwise.

The units described as the separation components may or may not be physically separate, and the components shown as units may or may not be physical units, i.e., may be located in one place or may be distributed over a plurality of network elements. The part or all of the units may be selected according to the actual needs to achieve objectives of embodiments of the present disclosure.

In addition, each function unit in the various embodiments of the present disclosure may be integrated in a processing unit, or each function unit may be separate physical existence, or two or more units may be integrated in a unit.

The functions can be stored in a computer-readable storage medium if they are implemented in the form of software functional units and sold or used as standalone products. Based on this understanding, the technical solution of the present disclosure contributing to the related art either essentially or in part or a part of the technical solution may be embodied in the form of a software product stored in a storage medium, including several instructions used to enable computer devices (which may be personal computers, servers, or network devices, etc.) to perform all or part of the steps described in the various embodiments of the present disclosure. The aforementioned storage medium includes a variety of media such as a U disk, a mobile hard disk, a read-only memory (ROM for short), a random access memory (RAM for short), a magnetic disk, or an optical disk.

As described above, only the specific embodiments of the present disclosure, the scope of the present disclosure is not limited thereto, and those skilled in the art will be able to easily think of variations or substitutions within the technical scope of the present disclosure, which should be covered within the scope of the present disclosure. Accordingly, the scope of protection of the present disclosure should be based on the scope of protection of the claims.

What is claimed is:

1. A battery protection board, comprising:
a first protection circuit, configured to be coupled to a charge and discharge circuit of a battery and configured to control the charge and discharge circuit to turn on or off;
a current sensing element, configured to be coupled to the charge and discharge circuit in series; and
a battery voltmeter, coupled to two terminals of the current sensing element and configured to detect a voltage drop generated by an impedance of the current sensing element and to determine an electric quantity of the battery according to the voltage drop during a charge and discharge process of the battery via the charge and discharge circuit.

2. The battery protection board according to claim 1, further comprising:
a temperature detection circuit, configured to detect a temperature of the battery,
wherein the battery voltmeter is coupled to the temperature detection circuit and is configured to:
determine an impedance of the current sensing element at a current temperature according to the temperature detected by the temperature detection circuit and a correspondence between the impedance of the current sensing element and the temperature;
determine a current flowing through the current sensing element according to the impedance of the current sensing element at the current temperature and the voltage drop generated by the impedance of the current sensing element at the current temperature; and
determine the electric quantity of the battery according to the current flowing through the current detecting element.

3. The battery protection board according to claim 2, wherein the temperature detection circuit is integrated in the battery voltmeter.

4. The battery protection board according to claim 1, wherein the first protection circuit comprises:
a field-effect transistor, configured to be located in the charge and discharge circuit; and
a controller coupled to the field-effect transistor and configured to control the charge and discharge circuit to turn on or off via the field-effect transistor.

5. The battery protection board according to claim 4, wherein the first protection circuit comprises two field-effect transistors provided back-to-back.

6. The battery protection board according to claim 4, wherein the current sensing element comprises the field-effect transistor.

7. The battery protection board according to claim 5, wherein the current sensing element comprises at least one of the two field-effect transistors.

8. The battery protection board according to claim 5, wherein the controller is coupled to one of the two field-effect transistors via a first terminal and coupled to another of the two field-effect transistors via a second terminal.

9. The battery protection board according to claim 1, wherein the current sensing element comprises a wire coupled in series in the charge and discharge circuit.

10. The battery protection board according to claim 1, wherein the first protection circuit comprises a switch.

11. The battery protection board according to claim 10, wherein the current sensing element comprises the switch.

12. The battery protection board according to claim 1, further comprising:
a second protection circuit, configured to be coupled to the charge and discharge circuit and configured to perform overvoltage and/or overcurrent protection to the charge and discharge circuit via a fuse.

13. A battery, comprising:
a charge and discharge circuit;
a cell coupled to the charge and discharge circuit; and
a battery protection board coupled to the cell, wherein the battery protection board comprises:
a first protection circuit, coupled to the charge and discharge circuit and configured to control the charge and discharge circuit to turn on or off;
a current sensing element, coupled to the charge and discharge circuit in series; and
a battery voltmeter, coupled to two terminals of the current sensing element and configured to detect a voltage drop generated by an impedance of the current sensing element and to determine an electric quantity of the battery according to the voltage drop during a charge and discharge process of the battery via the charge and discharge circuit.

14. The battery according to claim 13, wherein the battery protection board further comprises:
a temperature detection circuit, configured to detect a temperature of the battery,
wherein the battery voltmeter is coupled to the temperature detection circuit and is configured to:
determine an impedance of the current sensing element at a current temperature according to the temperature detected by the temperature detection circuit and a correspondence between the impedance of the current sensing element and the temperature;
determine a current flowing through the current sensing element according to the impedance of the current sensing element at the current temperature and the voltage drop generated by the impedance of the current sensing element at the current temperature; and
determine the electric quantity of the battery according to the current flowing through the current detecting element.

15. The battery according to claim 13, wherein the current sensing element comprises a wire coupled in series in the charge and discharge circuit.

16. A mobile terminal, comprising:
a charging interface; and
a battery coupled to the charging interface and comprising:
a charge and discharge circuit;
a cell coupled to the charge and discharge circuit; and
a battery protection board coupled to the cell the charge, wherein the battery protection board comprises:
a first protection circuit, coupled to the charge and discharge circuit and configured to control the charge and discharge circuit to turn on or off;
a current sensing element, coupled to the charge and discharge circuit in series; and
a battery voltmeter, coupled to two terminals of the current sensing element and configured to detect a voltage drop generated by an impedance of the current sensing element and to determine an electric quantity of the battery according to the voltage drop during a charge and discharge process of the battery via the charge and discharge circuit.

17. The mobile terminal according to claim 16, wherein the mobile terminal is configured to support a first charging mode and a second charging mode, a charging speed of the second charging mode is greater than a charging speed of the first charging mode.

18. The mobile terminal according to claim 17, wherein a charging current of the second charging mode is greater than a charging current of the first charging mode.

19. The mobile terminal according to claim 17, wherein a charging voltage of the second charging mode is greater than a charging voltage of the first charging mode.

20. The mobile terminal according to claim 17, wherein the mobile terminal is configured to perform a bidirectional communication with an adapter via the charging interface under the second charging mode.
